(19) United States
(12) Patent Application Publication
(10) Pub. No.: US 2005/0256939 A1
(43) Pub. Date: Nov. 17, 2005

(54) Automatic Configuration of Network Automation Devices

(75) Inventors: Ronald H. Naismith, North Andover, MA (US); Diego Areces, North Andover, MA (US)

Correspondence Address: SQUARE D COMPANY;INTELLECTUAL PROPERTY DEPARTMENT, 1415 SOUTH ROSELLE ROAD, PALATINE, IL, 60067, US

(73) Assignee: SCHNEIDER AUTOMATION SAS, Sophia Antipolis Cedex (FR)

(21) Appl. No.: 10/709,402

(22) Filed: May 3, 2004

(51) Int. Cl. G06F 15/16

(52) U.S. Cl. 709/219

(57) ABSTRACT

A system, method and apparatus for the automatic configuration of a factory automation device is described. The automatic configuration involves the identification of the device's network address, then involves the search for a configuration server. The configuration server contains the configuration record to download to the automation device, and may contain configuration records for a number of devices. As a result, a search must be made within the configuration server for the configuration record of the specific device. Once found, the configuration is downloaded from the configuration server to the automation device.

### CROSS REFERENCE TO RELATED APPLICATIONS

This application is related to U.S. patent application Ser. No. 09/635,280, filed Aug. 9, 2000, entitled “A Method and Apparatus for Programming a Factory Automation Device”, herein incorporated by reference. It is also related to U.S. patent application Ser. No. 09/973,068, filed Oct. 10, 2001 entitled “Method of Configuring an Automation Module on a TCP/IP Network” (herein incorporated by reference), which is based upon French Patent Application 00 13 191 filed Oct. 12, 2000.

### BACKGROUND OF INVENTION

Field of Invention

This application is in the field of factory and industrial automation, particularly in the area of networking in factory automation.

In the field of factory automation, the continuous operation of the factory is of critical importance to the operators of the factory. Vendors of factory automation equipment design their equipment to allow for non stop, maintenance free operation in harsh environments. Equipment is designed to handle extended temperature ranges, excessive vibration and shock, and sometimes for contaminants in the air. In spite of the best of efforts by automation vendors, the harshness of factory environments sometimes causes equipment to fail.

Since many factories operate 24 hours a day, 7 days a week, it is very important to return the factory to an operating state as soon as possible. Factory downtime can cost the factory operators millions of dollars a day for downtime. Failures also occur at random times, and it is not uncommon for a failure to occur on a second, third or weekend shift, when the maintenance staff is limited, and the plant engineers are unlikely to be working.

As a result, automation vendors search for means for making the replacement of failed units as simple as possible. This allows untrained operators or factory maintenance staff to replace a failed unit with the minimum of training or instruction.

Factory automation equipment, such as programmable logic controllers (PLCs), IO modules (such as analog input, digital input, analog output, or digital output modules), motion controllers, vision controllers, invertors, encoders, process controllers, numerical controllers, relays, sensors, bar code readers, weighing stations, cubing machines, power monitoring equipment, breakers, industrial power monitors, and a number of other devices are now connected to networks and are becoming increasingly intelligent. As a result, steps need to be taken to configure or program both the device and its network parameters. Traditionally, this requires a plant engineer to program the device and a network engineer to set the network parameters, especially on complex networks such as Ethernet.

However, this complexity of individual devices is in direct conflict with the goal of simplicity in the replacement of failed units. This invention is designed to overcome this conflict by allowing for the easy replacement of factory automation devices as well as to solve other problems in factory automation.

### SUMMARY OF INVENTION

This invention describes a method of automatically configuring an automation device, which could be a programmable logic controller, an IO module, or any another automation device, operating on an automation specific protocol, such as MODBUS/TCP, MODBUS, or another protocol, the method including the steps of searching for the address of a configuration server, searching the memory of the configuration server once it is found, and loading the configuration from the configuration server to the automation device over the automation specific protocol.

This invention further describes a factory automation system that automatically configures automation devices, which could be a programmable logic controller, an IO module, or any another automation device, on an automation specific network, such as MODBUS/TCP, MODBUS, or another protocol, wherein the system includes automation devices that are designed to search for a configuration server and then search to find specific configurations within the configuration server, where the configuration server contains a linked list of configurations that are available to the automation devices.

This invention also describes an automation device, which could be a programmable logic controller, an IO module, or any another automation device, that is connected to an automation specific network, such as MODBUS/TCP, MODBUS, or another protocol, where the automation device is designed to search the network for a configuration server, then search the configuration server for its specific configuration, and then load the configuration from the configuration server into the automation device.

This invention also describes the replacement of a first automation device with a second automation device on the automation specific network, wherein the identifier for the first device is replaced with the identifier of the second within the configuration server, and the second automation device is designed to search the network for a configuration server, then search the configuration server for its specific configuration, and then load the configuration from the configuration server into the automation device.

Other systems, methods, features, and advantages of the present invention will be, or will become, apparent to one having ordinary skill in the art upon examination of the following drawings and detailed description. It is intended that all such additional systems, methods, features, and advantages be included within this description, be within the scope of the present invention, and be protected by the accompanying claims.

### BRIEF DESCRIPTION OF DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a simplified block diagram showing a factory network;

FIG. 2 is a flowchart demonstrating a possible startup sequence for a factory automation device utilizing the invention; and

FIG. 3 is an example of a memory map of a configuration server's memory in accordance with the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspects of the invention to the embodiments illustrated.

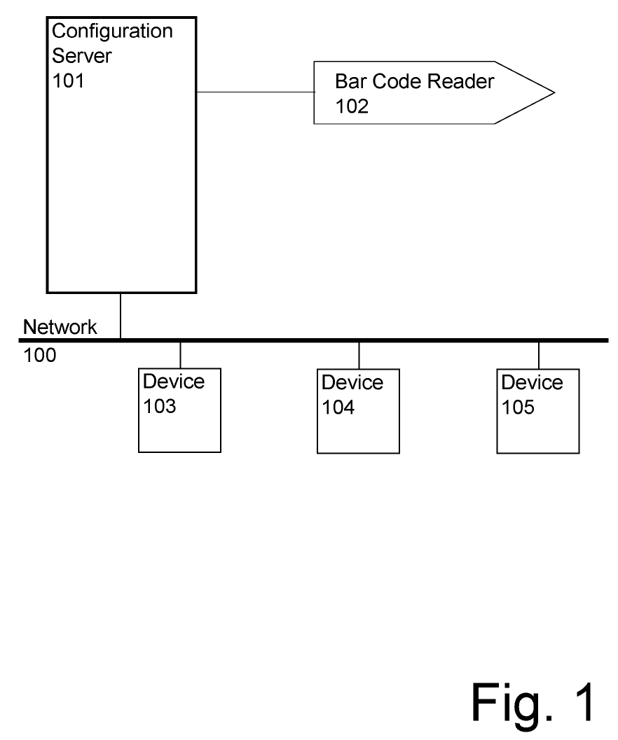

FIG. 1 is a simplified diagram of a factory network system. It contains a network 100 that connects automation devices 103, 104 and 105, and a configuration server 101. Other devices and servers can also be connected to the network 100. Moreover the configuration server 101 may perform other functions in addition to those described here.

The network 100 uses an automation specific protocol such as MODBUS, MODBUS/TCP, Devicenet, Profinet, CANOpen, Ethernet/IP, Fieldbus Foundation, or other protocol designed specifically for use in automation.

The MODBUS and MODBUS/TCP protocols are defined in the MODBUS/IDA submission to the IEC (Commission Electrotechnique Internationale, www.iec.ch), herein incorporated by reference. The MODBUS/TCP protocol is a set of protocols that operate on Ethernet, and are often operating over the Internet or over an Intranet. As a result, the connectivity provided by network 100 does not need to be local, but instead could connect devices 103, 104, and 105 and server 101 that are thousands of miles apart.

Devices 103, 104, and 105 are factory automation devices that have network connectivity and intelligence. Because of the intelligence, these devices can be configured both for their network parameters and for their operation within the factory environment. However, the configuration of these parameters are often specific to the particular function that the particular device is doing in the specific location in the plant. It would typically not be desirable for the configuration of device 103 to be placed in device 104. However, in some circumstances, this may be required. With potentially thousands of factory automation devices in a factory, the management of the configurations for each device is quite difficult. Should a device 103 fail, then the device needs to be replaced with the same type of device, and the same configuration needs to be loaded into the device. When first installed, a plant engineer does the programming and make sure that the new configuration is tested. Should a replacement be required on an off shift, the plant engineer may not be available. In this case, the configuration needs to be downloaded with the minimum of training. Since a type of device is often used to provide many different types of functionality, it can not be stored pre-configured in the tool crib.

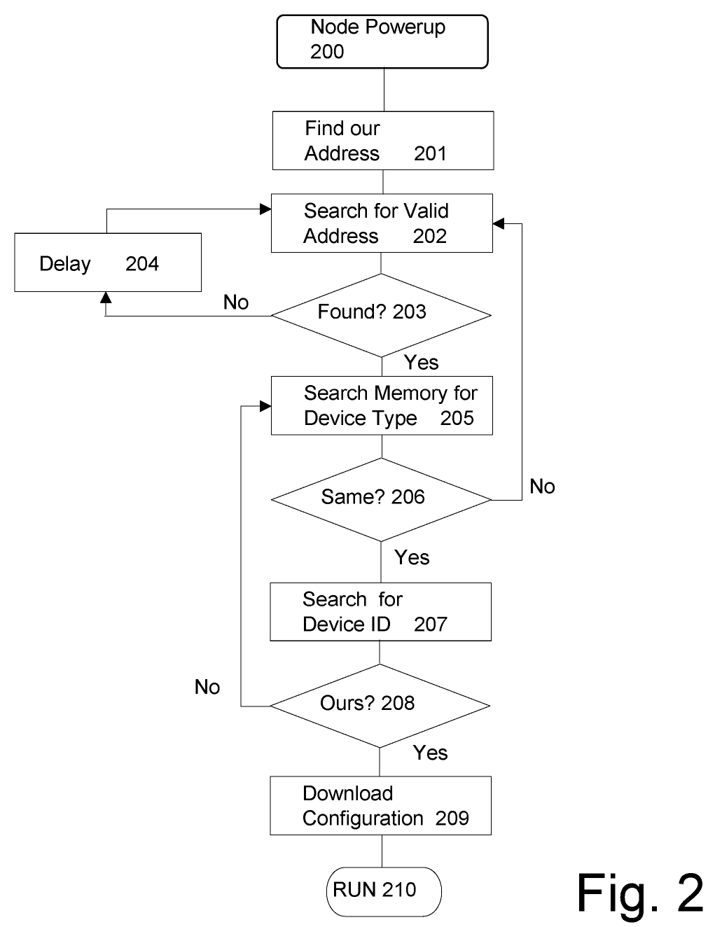

As a result, when the replaced device 103 is connected to the network 100, it needs a specific configuration to perform the function that the original device was performing. The device 103 requests a download from the Configuration Server 101 when it is replaced. This process is further discussed below in the discussion of FIG. 2.

The configuration server 101 has an attached bar code reader 102. The configuration server 101 could be a personal computer or a programmable logic controller or any other device with the storage capability to store the configurations for the devices 103, 104, and 105. The configuration server 101 is also connected to the network 100.

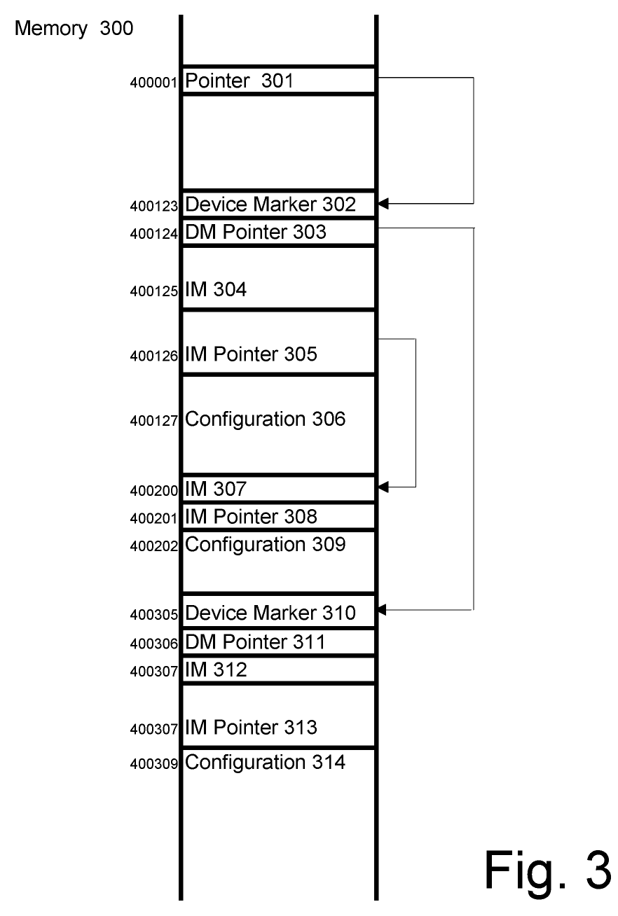

In one possible embodiment, the network 100 is a MODBUS/TCP network. The configuration server 101 is a programmable logic controller or a personal computer emulating a programmable logic controller's memory map. The memory of a programmable logic controller using a MODBUS type protocol has an address range from 40000 to 46535 words. The configuration is downloaded to the devices 103, 104 or 105 from that memory. Further discussion of the memory map can be found below in the discussion of FIG. 3.

Connected to the configuration server 101 is bar code reader 102. When one of devices 103, 104 or 105 fails, the operator removes the device, tells the configuration server 101 that a replacement will occur, scans a bar code on the device 103, 104, or 105 with the bar code reader 102, and then scans the bar code of the replacement unit. The bar code on each device contains an identifier for the device, such as the unique MAC network address. The new device 103, 104, or 105 is then connected to the network 100 in the same way the failed unit was connected. The new device 103, 104, 105 then searches and requests a download of its configuration from the configuration server 101. Further information concerning the use of bar codes and bar code readers for the replacement of automation devices can be found in U.S. patent application Ser. No. 10/707,482 “Bar coded addressing technique”, herein incorporated by reference.

While the above description discusses the replacement of a failed device 103, the techniques described here could also be used to restart a network 100 of devices 103, 104, 105 after a power failure, or in the configuration of a new device 103, 104, 105 where the configuration is stored in the configuration server 101 by a programming tool.

FIG. 2 is a flow chart of the operation of the devices 103 (or 104 or 105) upon power up. After the device 103 is turned on, it executes a normal power up sequence 200. This sequence will initialize the device and will start the basic communications stack for accessing the network 100.

The next step involves finding the address 201 of the device 103. There are a number of schemes available for determining the address of the device, as seen in the references that are included in this application. The simplest mechanism on an Ethernet network is to have the bar code reader 102 scan the old MAC address and the new MAC address, and replace the address in the DHCP or BOOTP tables. These tables are stored in the configuration server 101. As the device 103 starts up the protocol stacks, it sends out a BOOTP/DHCP message to ask for its IP address. The response to this message will provide the device 103 with its address, allowing the stack to complete its operation. For other types of networks, this may involve setting of thumb wheels on the device itself or connecting via a known address to set the new address.

Once the device 103 has found its address, the next step that it needs to perform is to find the address of the configuration server 101. This is first done by searching 202 the network for the addresses of devices that are available on the network 100. This search 202 can use one of several schemes. The search 202 could start with address 1 on the local sub network and linearly search from xx.xx.xx.01 to xx.xx.xx.255. Alternatively, a search could use the MAC addresses of itself, and search linearly above and below that address on the assumption that the server was manufactured by the same vendor (and therefore has a similar MAC address). Another scheme involves reading the ARP tables on a local machine and searching 202 each address in that table for the server. A read memory message is then sent to each server to see the address is still present on the network and to see if the device at that address can respond using the automation specific protocol. In the case of our example, to see if the device at that address responds on IP port 502, assigned to MODBUS/TCP.

If no address is found 203, the device 103 goes into a delay 204 for 30 seconds or so, and restarts the search 202. This restart is necessary for the case where the configuration server powers up more slowly than the device, and becomes available later.

If the address is found 203, then the unit at that address is searched to see if the address is a configuration server 101. The search is best done by reading memory 300 to see if there is a linked list present that contains device types and device IDs. The memory map 300 in the server 101 is defined in FIG. 3 and described later in this document. However, the configuration server itself could perform the memory search in an alternative implementation. In this alternative, the automation device 103 would provide the configuration server 101 with the Device ID, and then the configuration server would download the configuration 306 to the automation device 103 if the configuration for that particular automation device 103 is found.

Next, the memory 300 of the configuration server 101 is searched 205 to see if there are any records of the same device type as the device 103. Given that the configuration server is a linked list of configuration records, this process is a search of the linked list for the given device type.

If no records are found that are the same 206 as this device 103, then the device 103 will continue searching for valid addresses 202. It is possible that there are multiple configuration servers 101 on a network 100, so each may have to be searched to find the correct configuration record.

If the device types do match, then the next step is to search for the Device ID 207. This search finds the exact configuration for the device 103. Although a number of schemes could be used to match devices, for an Ethernet network, the MAC address is perhaps the most unique number that is readily available. MAC addresses are assigned as unique blocks to manufactures to assign to individual products and are unique to each product that is manufactured. Serial numbers could also be used, as could IP addresses or URLs. This search is down a linked list of configuration records and involves a simple comparison of the device's 103 MAC address to the individual marker 304 in memory 300.

If the address is not found at step 208, then the search for device type resumes at 205.

If a match at step 208 has been found, then the search has been successful. The configuration is now downloaded 209 to the new device 103. The term configuration is broad, and could be as simple as a byte or two of information, for either the network interface, the device, a sub-device, or any combination thereof, or could involved the download of a set of multiple programs, parameters, and data for a set of modules.

The configuration download 209 occurs after first verifying that the correct record has been found. A CRC-16 check is done to assure that a valid configuration has been found, either before or after the configuration is sent from the configuration server 101 to the device 103. The device's MAC address has already been checked in the search 207, and additional information may be checked to increase the assurance that this is a valid configuration record for this particular device 103. The configuration is downloaded by the device 103 reading the memory of the configuration server 101 at the location of the found configuration.

Once the configuration download 209 has completed and has been verified, the device 103 starts operating 210 using the downloaded configuration.

FIG. 3 shows a possible memory map 300 of the configuration server 101. The example here is of a unit that uses the memory addressing scheme dictated by the MODBUS protocol. This addressing scheme utilizes a memory bank 65535 words long starting at 400001.

The memory is organized as a linked list starting at 400001 with a pointer 301 to the linked list. This pointer points to a device marker 302.

The device marker 302 identifies the type of device configuration records that are stored at this location. It is used in the search for device type 205 step. This marker could contain a numeric value for the part number of the device or a string that contains the product name of the device.

After the device marker 302 is a pointer 303 to the next device type 310 in the linked list. If this is the last device type in the list, a null pointer is entered, typically a zero. In FIG. 3, this is the case for pointer 311.

After the pointer 303 is the first individual marker 304 for a specific device. The individual marker 304 could be a MAC address, and is used in step 207 in the search for the specific device.

The individual marker 304 is followed by a pointer 305 to the next individual marker 307 in the linked list. This next individual marker 307 also has a pointer 308 to the next record. Should the pointer 308 be null, then this is the end of the list of configuration records for this device type 302.

After the individual marker 304 and its pointer 305, we have the configuration 306 that is downloaded to device 103 if the device marker 302 matches its device type and if its individual marker 303 matches its MAC address.

The configurations 309 and 314 contain the configurations for other devices, as identified by their individual markers 307 and 312.

The memory structure 300 containing the linked list of configurations is created with a utility software that may run on the configuration server 101 or on another system. This software may upload configurations from devices to archive them in the configuration server or may be part of the programming software that is used to program the device 103, 104, and 105.

It should be emphasized that the above-described embodiments of the present invention, particularly, any preferred embodiments, are merely possible examples of implementations, merely setting forth for a clear understanding of the principles of the invention. Many variations and modifications may be made to the above-described embodiment(s) of the invention without substantially departing from the spirit and principles of the invention. All such modifications are intended to be included herein within the scope of this disclosure and the present invention and protected by the following claims.

1. A method of automatically configuring a first automation device connected to a network system using an automation specific protocol, the steps comprising:
searching for an address of a configuration server by said first automation device;
searching a memory of the configuration server for a configuration designated for said first automation device; and
loading said configuration from the configuration server into said first automation device using the automation specific protocol.

2. The method of claim 1 wherein the automation specific protocol is MODBUS/TCP.

3. The method of claim 1 wherein the automation specific protocol is MODBUS.

4. The method of claim 1 wherein the first automation device is a programmable logic controller.

5. The method of claim 1 wherein the first automation device is an IO module.

6. The method of claim 1 further comprising:
scanning a bar code identifier of the first automation device;
scanning a bar code identifier for a second automation device;
replacing the bar code identifier for the first automation device in the memory of the configuration in the configuration server with the bar code identifier of the second automation device.

7. The method of claim 1 further wherein the search of the memory of the configuration server is performed by the configuration server.

8. A factory automation system for the automatic configuration of automation devices, the system comprising:
a network utilizing an automation specific protocol;
a configuration server connected to the network, containing at least one configuration for the automation devices, wherein said at least one configuration is available to said automation devices;
the automation devices connected to the network, capable of searching for the configuration server on the network utilizing the automation specific protocol, finding a specific configuration within said configuration server, and loading the specific configuration.

9. The factory automation system of claim 7 wherein the automation specific protocol is MODBUS/TCP.

10. The factory automation system of claim 7 wherein the automation specific protocol is MODBUS.

11. The factory automation system of claim 7 wherein the automation devices comprise of at least one programmable logic controllers.

12. The factory automation system of claim 7 wherein the automation devices comprise of at least one IO module.

13. The factory automation system of claim 7 wherein the automation system is capable of the replacement of at least one automation device through the removal of the at least one automation device, the connection of at least one replacement automation device, wherein the at least one replacement device is capable of searching for the configuration server on the network utilizing the automation specific protocol, finding a specific configuration for the at least one automation device within said configuration server, and loading the specific configuration into the at least one replacement automation device.

14. An automation device comprising:
a connection to a network using an automation specific protocol;
a process executing on the automation device, said process accessing the network,
said process capable of searching the network using the automation specific protocol for a configuration server, said configuration server containing a specific configuration for the automation device,
said process further capable of searching the configuration server for the specific configuration for said automation device, and loading said specific configuration into the automation device.

15. The automation device of claim 12 wherein the automation specific protocol is MODBUS/TCP.

16. The automation device of claim 12 wherein the automation specific protocol is MODBUS.

17. The automation device of claim 12 wherein the automation device is a programmable logic controller

18. The automation device of claim 12 wherein the automation device is an IO module.
